(19) United States
(12) Patent Application Publication
(10) Pub. No.: US 2006/0001695 A1
(43) Pub. Date: Jan. 5, 2006

(54) Inkjet printer

(75) Inventors: Jin-Ho Park, Yongin-si (KR); Hyun-Ki Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/132,267

(22) Filed: May 19, 2005

(30) Foreign Application Priority Data
Jul. 1, 2004 (KR) 10-2004-0051010

(51) Int. Cl. B41J 2/165

(52) U.S. Cl. 347/30

(57) ABSTRACT

A printing head including a nozzle unit having a length corresponding to a width of a paper and prints an image on the paper by projecting ink onto the paper while staying stationary. The nozzle unit is divided into a plurality of nozzle sections. A plurality of cap members is provided with each cap member corresponding to at least one nozzle section. A cap drive unit moves the plurality of cap members between a a capped position and an uncapped position. A motor drives the cap drive unit.

### CROSS-REFERENCE TO RELATED APPLICATIONS

This application claims the benefit under 35 U.S.C. § 119(a) of Korean Patent Application Serial No. 10-2004-0051010, filed on Jul. 1, 2004, the entire disclosure of which is hereby incorporated by reference.

### BACKGROUND OF THE INVENTION

1. Field of the Invention

The present invention relates to an inkjet printer. More particularly, the present invention relates to an inkjet printer with a printing head having a nozzle that is as wide as the paper being printed on.

2. Description of the Related Art

In general, an inkjet printer is a device for forming an image on paper by projecting ink onto the upper surface of the paper from a printing head. The printing head is generally spaced apart from the upper surface of the paper at a desired interval and reciprocates in a direction perpendicular to the feeding direction of the paper. The printing head includes a nozzle unit with a plurality of nozzles. If the nozzle unit is exposed to the atmosphere for a long time, the ink dries and clogs the nozzle. Also, dust in the air adheres to the nozzle and clogs the nozzle. The inkjet printer therefore includes a capping unit to shield the nozzle unit from the air when the printer is not in operation. The capping unit prevents the nozzle unit from drying or becoming contaminated by pollutants. Examples of capping units are disclosed in U.S. Pat. No. 6,467,872 and Korean Unexamined Patent Publication No. 1998-925, both of which are incorporated by reference in their entirety.

Recently, there have been attempts to achieve high-speed printing by using a printing head having a nozzle unit that is as wide as the paper being printed on, instead of a reciprocating printing head. In inkjet printers employing such a nozzle unit, the printing head is basically stationary while the paper is transferred. As such, the drive unit of the inkjet printer can be simplified and high-speed printing can be achieved. The length of the nozzle unit for the printing head is about 210 mm to correspond to a paper such as A4 size paper, without including any margins. To accommodate these wider printing nozzle units, there is a need for a new capping unit.

### SUMMARY OF THE INVENTION

An aspect of the present invention is to solve at least the above problems and/or disadvantages and to provide at least the advantages described below. Accordingly, an aspect of the present invention is to provide an inkjet printer employing a printing head having a nozzle unit with a length that corresponds to the width of a paper being printed on and a capping unit for capping the nozzle unit.

According to an aspect of the present invention, an inkjet printer includes a printing head with a nozzle unit having a length corresponding to the width of a paper being printed on, the printing head printing an image on the paper by projecting ink onto the paper from a stationary position, the nozzle unit being divided into a plurality of nozzle sections, a plurality of cap members each corresponding to at least one nozzle section, a cap drive unit for moving the plurality of cap members between a capped position and an uncapped position, and a motor for driving the cap drive unit.

The plurality of cap members may be divided into a plurality of cap groups including at least one cap member, and the cap drive unit may sequentially move the cap groups to the uncapped position one by one.

The cap drive unit may move the cap groups to the uncapped position starting from the cap group located at one side of the paper being printed. Alternatively, the cap drive unit may move the cap groups to the uncapped position starting from the cap group located at the center of the paper being printed.

The cap drive unit may include a plurality of rotary cams corresponding to the plurality of cap members, with each rotary cam including a first cam supporting the cap member at the capped position, a second cam supporting the cam member at the uncapped position and spirally engaged to the first cam, and a ramp for selectively allowing the first and second cams to be engaged depending upon the direction of rotation of the cam; a plurality of resilient members for applying a resilient force to the plurality of cap members to force the cap members toward the capped position; an uncapping unit for rotating the rotary cam in a third direction to move the plurality of cam members in a direction opposite the resilient force when the motor rotates in a first direction; and a capping unit for rotating the rotary cam in a fourth direction to allow the plurality of cam members to move in the same direction as the resilient force when the motor rotates in a second direction.

The inkjet printer may further comprise locking means for locking the rotary cam in the capped position or the uncapped position.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of an inkjet printer according to an embodiment of the present invention;

FIGS. 2 and 3 are top views of exemplary nozzle units;

FIGS. 4A, 4B and 4C are top views of exemplary cap members;

FIGS. 5A and 5B are top views showing examples of divided cap groups;

FIG. 6 is a top view of an embodiment of a cap drive unit;

FIG. 7 is a perspective view of an embodiment of a cap member;

FIGS. 8 and 9 are top views of an embodiment of a rotary cam;

FIG. 10 is a cross-sectional view of a ramp;

FIGS. 11 and 12 are top views showing the interrelationship between a gear of a rotary cam and a first gear;

FIG. 13 is a top view of an embodiment of an uncapping unit;

FIG. 14 is a top view showing the operation of a first delaying means;

FIG. 15 is a top view of an embodiment of a capping unit;

FIG. 16 is an exploded perspective view of an embodiment of the capping unit in FIG. 15;

FIG. 17 is a side view showing the operation of a capping unit;

FIG. 18 is a top view showing the operation of a second delaying means;

FIG. 19 is an exploded perspective view of another embodiment of a capping unit;

FIG. 20 is a top view of an embodiment of a first delaying means;

FIG. 21 is a top view of another embodiment of a first delaying means;

FIG. 22 is a top view of another embodiment of a first delaying means;

FIG. 23 is a top view of another embodiment of a cap drive unit;

FIG. 24 is a top view of another embodiment of a cap drive unit; and

FIG. 25 is a top view of another embodiment of a cap drive unit.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

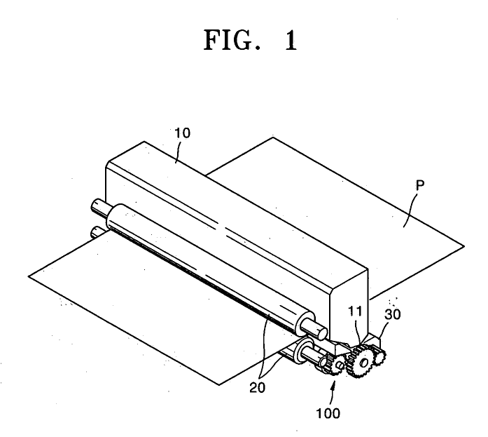

FIG. 1 is a perspective view showing an inkjet printer according to an embodiment of the present invention. Referring to FIG. 1, a paper P is transferred by a pair of rollers 20 which mate with one another and rotate together. A printing head 10 is located above the paper P and includes a nozzle unit 11 having a length corresponding to the width of the paper P. The printing head 10 prints an image on the paper P by projecting ink from the stationary nozzle unit 11 onto the paper P while the paper P is transferred by the pair of rollers 20.

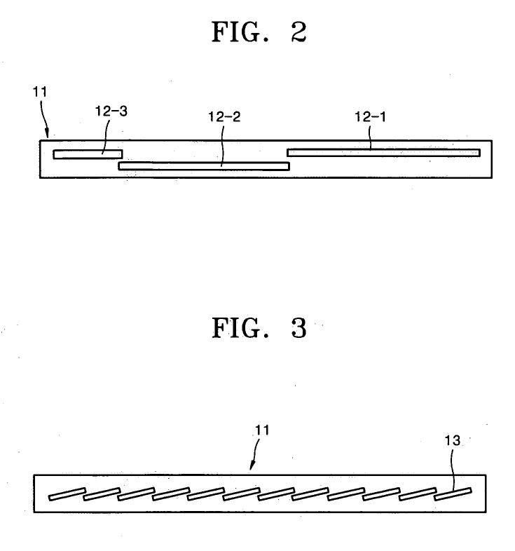

FIGS. 2 and 3 are top views showing exemplary embodiments of the nozzle unit 11. Referring to FIG. 2, the nozzle unit 11 in this embodiment is divided into three nozzle sections 12-1, 12-2 and 12-3. Each of the nozzle sections 12-1, 12-2 and 12-3 has a plurality of nozzles (not shown) for projecting ink. Referring to FIG. 3, the nozzle unit 11 has a plurality of nozzle sections 13 across the width of the paper P. Each of the nozzle sections 13 is angled with respect to the direction of the width of the paper P. Each of the nozzle sections 13 has a plurality of nozzles (not shown) for projecting ink. While FIGS. 2 and 3 show exemplary nozzle units, it should be understood that any suitable nozzle unit can be used, and the scope of the present invention is not limited to the particular embodiments shown in FIGS. 2 and 3.

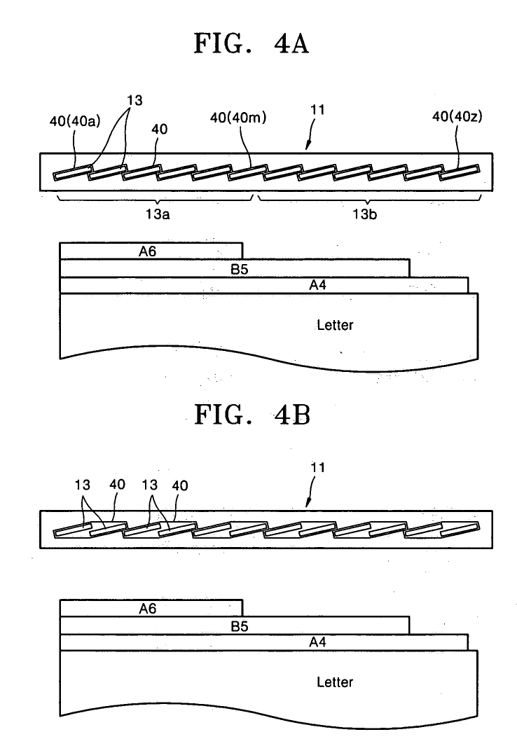

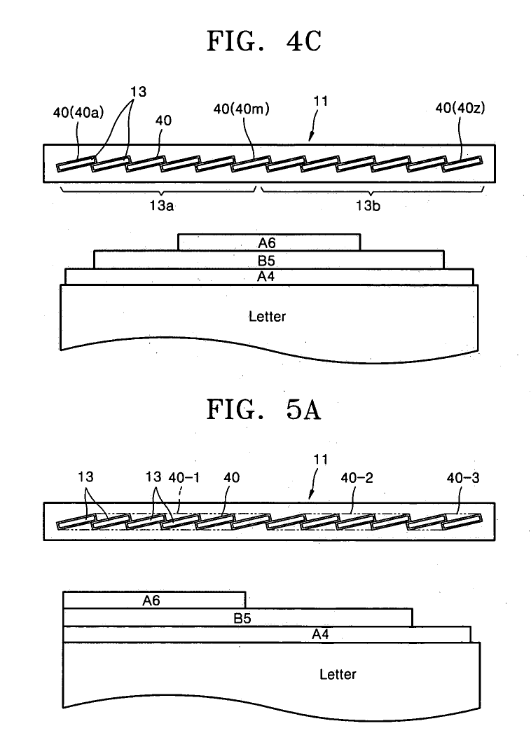

An inkjet printer employing the nozzle unit 11 in FIG. 3 will now be described. Referring to FIG. 4A, the inkjet printer includes a plurality of cap members 40 to prevent the nozzle unit 11 from drying out or becoming polluted. In FIG. 4A, one nozzle section 13 is allocated to one cap member 40. Alternatively, as shown in FIG. 4B, two nozzle sections 13 may be allocated to one cap member 40. The number of cap members 40 does not need to be identical with the number of nozzle sections 13, and various combinations in addition to those shown in FIGS. 4A and 4B may be used. The exemplary embodiment using the same number of cap members as nozzle sections 13 will be now described with reference to FIG. 4A.

The inkjet printer includes a cap drive unit 100 for moving a plurality of cap members 40 between a capped position and an uncapped position and a motor 30 for driving the cap drive unit 100. In a conventional cap drive unit, the motor 30 needs to produce enough torque to move the plurality of cap members 40 en masse, and that requires a large and expensive motor. In the illustrated embodiment, the cap members are not moved en masse, however. To explain further, the nozzle unit 11 may be long enough to cover a letter-sized paper. The inkjet printer may print an image on a paper P smaller than the letter-sized paper, such as A4-sized, B5-sized or A6-sized paper. When an image is printed on smaller sized paper, such as A6-sized paper, only the nozzle section 13a is utilized, and the remaining nozzle section 13b is not utilized, as shown in FIG. 4A. If the nozzle section 13b is exposed to the atmosphere when an image is printed, the nozzles may dry out. To prevent this, in the illustrated embodiment, it is possible to uncap only the nozzle section 13a used for printing and to cap the remaining nozzle section 13b. To this end, the cap drive unit 100 of this embodiment sequentially moves a plurality of cap members 40 to the uncapped position one by one, such that only cap members 40 covering the nozzle section 13a used for printing can be moved to the uncapped position. When the paper P is aligned to one side of the printing unit regardless of the width of the paper, as illustrated in FIG. 4A, the cap members 40 are sequentially uncapped starting from the cap member 40a located at the one side of the paper and proceeding across the width of the paper. When the paper P is aligned at the center of the printer, as shown in FIG. 4C, the cap members 40 are sequentially uncapped starting at the center and moving outward. To move the cap members 40 into the capped position, the cap members 40 are moved in the reverse sequence.

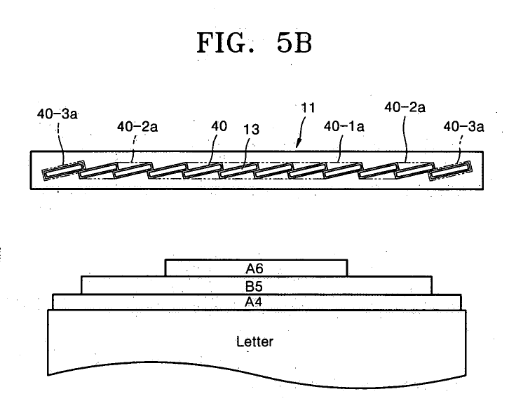

The plurality of cap members 40 may be divided into multiple cap groups 40-1, 40-2 and 40-3, as shown in FIG. 5A. Each of the cap groups 40-1, 40-2 and 40-3 includes at least one cap member 40. For example, the cap group 40-1 covers the A6-sized paper, while the cap groups 40-1 and 40-2 cover the B5-sized paper. The cap groups 40-1, 40-2 and 40-3 collectively cover A4-sized paper and letter-sized paper. The division of the cap groups shown in FIG. 5A may be used when the paper is aligned to one side of the printer regardless of the width of the paper. The plurality of cap members 40 may be divided into cap groups 40-1a, 40-2b and 40-3c as shown in FIG. 5B when the paper P is aligned at the center of the printer. For example, the cap group 40-1a covers A6-sized paper, while the cap groups 40-1a and 40-2a cover the B5-sized paper. The cap groups 40-1a, 40-2b and 40-3c collectively cover A4-sized paper and letter-sized paper. Of course, any suitable grouping of caps can be provided to cover any desired paper widths, in addition to the above embodiments shown in FIGS. 5A and 5B.

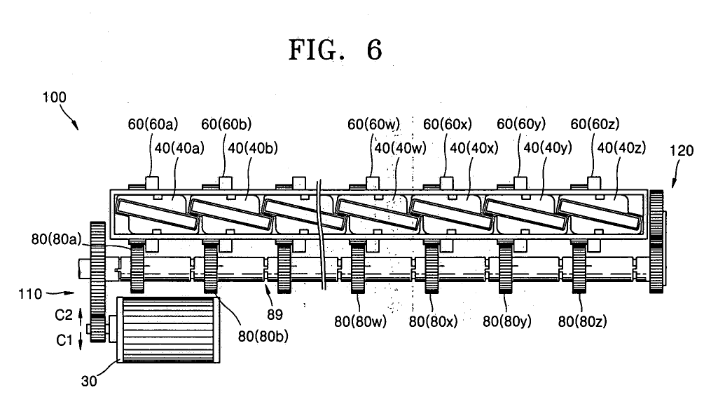

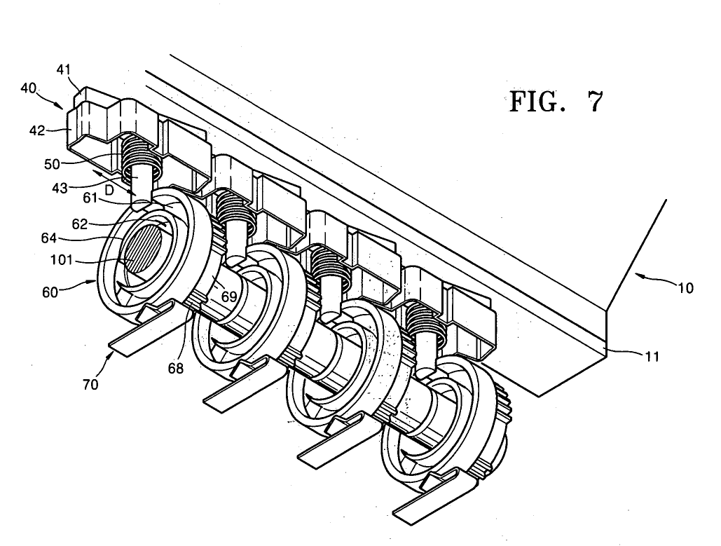

Referring to FIG. 6, the cap drive unit 100 includes a plurality of rotary cams 60 positioned under the plurality of cap members 40, an uncapping unit 110 and a capping unit 120. The uncapping unit 110 and capping unit 120 rotate the plurality of rotary cams 60 to move the plurality of cam members 40 between the capped and uncapped positions.

Referring to FIG. 7, the cap member 40 includes a cap 41, a frame 42, and an arm 43. The cap 41 tightly contacts the nozzle unit 11 and is preferably made of rubber. The cap 41 is coupled to the frame 42, and the arm 43 extends downwardly from the frame 42.

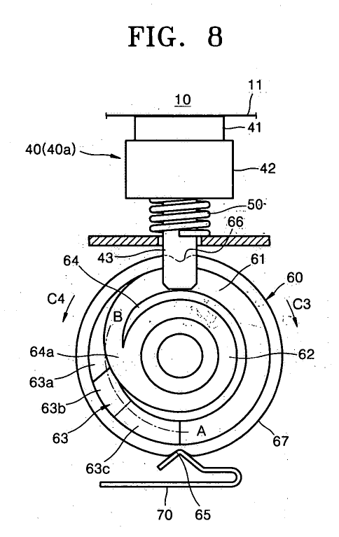

The rotary cam 60 includes first and second cams 61 and 62, as shown in FIG. 8. The first cam 61 is located nearer the outer diameter of the rotary cam 60, while the second cam 62 is located towards the interior of the rotary cam 60. The first and second cams 61 and 62 are divided by a partition 64 that has an opening 64a. The first and second cams 61 and 62 are spirally coupled to each other through the opening 64a. The first and second cams 61 and 62 are selectively coupled by a ramp 63, depending on the direction of rotation of the rotary cam 60.

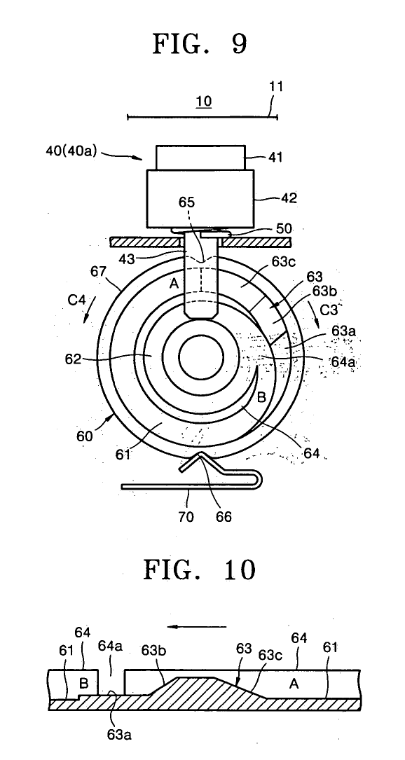

Referring to FIG. 8, the cap 41 contacts the nozzle unit 11. The first cam 61 supports the arm 43, thereby supporting the cap member 40 in the capped position. To move the cap member 40 to an uncapped position, the rotary cam 60 is rotated in a third direction C3. FIG. 10 is a cross-sectional view of a section taken along the line A-B in FIG. 8. Referring to FIG. 10, the ramp 63 includes an upward stepped portion 63a formed on the first cam 61 to guide the arm 43 from the first cam 61 to the second cam 62 through the opening 64a when the rotary cam 60 is rotated in the third direction C3. When the rotary cam 60 is rotated in the third direction C3, for example, at an angle of 180 degrees, the second cam 62 supports the arm 43, and the cap 41 is spaced apart from the nozzle unit 11, as shown in FIG. 9. The second cam 62 supports the cap member 40 in the uncapped position. Even though the rotary cam 60 is continuously rotated in the third direction C3, with the arm 43 being supported by the second cam 62, the arm 43 is guided by the partition 64 and the stepped portion 63a so that it is continuously supported by the second cam 62.

The rotary cam 60 is rotated in a fourth direction C4 to move the cap member 40 back to the capped position. When the rotary cam 60 is rotated in the fourth direction C4, the stepped portion 63a guides the arm 43 from the second cam 62 to the first cam 61 through the opening 64a. When the rotary cam 60 is rotated in the fourth direction C4 and the cam member 40 is being supported by the first cam 61, it is necessary to continuously support the cap member 40 by the first cam 61. To accomplish this, as shown in FIG. 10, the ramp 63 includes an upward inclined portion 63c that extends from the first cam 61 and a downward inclined portion 63b that extends from the upward inclined portion 63c to the stepped portion 63a. Preferably, the upward inclined portion 63c has a top lower than the partition 64. With such a construction, when the cap member 40 is being supported by the first cam 61 and the rotary cam 60 is rotated in the fourth direction C4, the arm 43 is sequentially supported by a section A of the first cam 61, the upward inclined portion 63c, the downward inclined portion 63b, the stepped portion 63a, and a section B of the first cam 61. Thus, the cap member 40 is continuously supported by the cam 61. Preferably, the arm 43 is mounted so that it slightly moves in the direction indicated by the arrow D in FIG. 7.

The cap drive unit 100 also includes a locking means for locking the rotary cam 60 in the capped position and the uncapped position. Referring to FIG. 8, the locking means includes first and second recessed locking portions 65 and 66 formed at an outer periphery 67 of the rotary cam 60, and a resilient engaging member 70 resiliently contacted with the outer periphery 67 of the rotary cam 60. The first and second locking portions 65 and 66 are spaced apart from each other at a distance corresponding to the phase difference between the first and second cams 61 and 62. In other words, in the illustrated embodiment, since the first and second cams 61 and 62 are spaced apart from each other at an angle of 180 degrees, the first and second locking portions 65 and 66 are spaced apart from each other at an angle of 180 degrees. As shown in FIG. 8, when the cap member 40 is in the capped position, the resilient engaging member 70 resiliently engages the first locking portion 65. During the rotation of the rotary cam 60, the resilient engaging member 70 resiliently contacts the outer periphery 67 of the rotary cam 60. As shown in FIG. 9, when the cap member 40 is located in the uncapped position, the resilient engaging member 70 resiliently engages the second locking portion 66.

The cap drive unit 100 also includes a plurality of resilient members 50 that apply a resilient force to the cap member 40 in a direction towards the capped position as shown in FIGS. 7 and 8. The uncapping unit 110 rotates the rotary cam 60 in the third direction C3 to cause the cap member 40 to move in a direction against the resilient force of the resilient member 50 when the motor 30 rotates in the first direction C1. The capping unit 120 rotates the rotary cam 60 in the fourth direction C4 to cause the cap member 40 to move in a direction toward the resilient force of the resilient member 50 when the motor 30 rotates in the second direction C2. With this construction, the load applied to the motor 30 is very small when the cap member 40 is moved to the capped position.

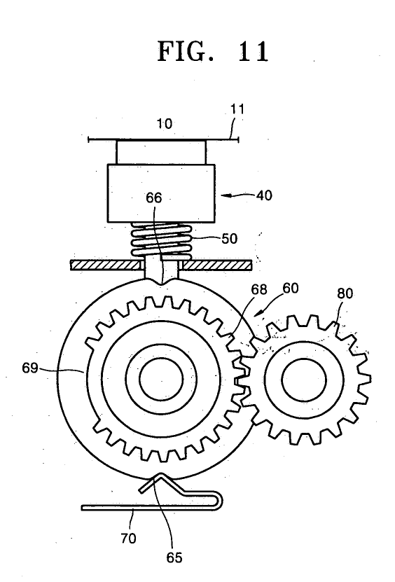

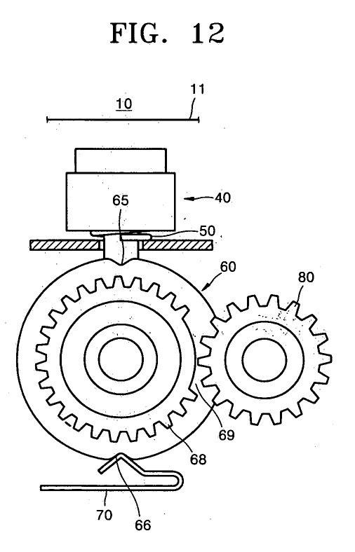

Referring to FIGS. 6, 11, 12 and 13, the uncapping unit 110 includes a plurality of geared portions 68 corresponding to the plurality of rotary cams 60, a plurality of first gears 80 corresponding to the plurality of rotary cams 60, and a plurality of first delaying means 89 disposed between the first gears 80. As shown in FIG. 11, a first gear 80 meshes with a geared portion 68. The geared portion 68 has an idle portion 69 with no teeth. The idle portion 69 is located at a position that corresponds to the uncapped position of the cap member 40, as shown in FIG. 12. Thus, in that position, when the first gear 80 is rotated, the rotary cam 60 does not rotate. Preferably, the geared portion 68 of the rotary cam 60 has the same number of teeth as that of the first gear 80.

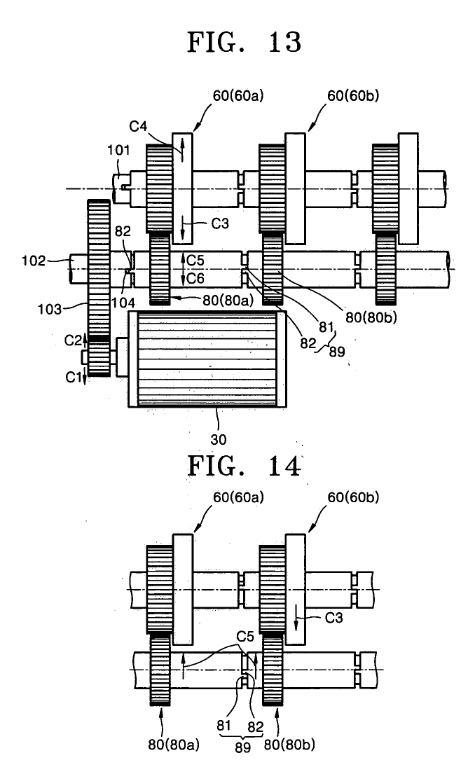

The plurality of rotary cams 60 are axially aligned with one another. Also, the plurality of first gears 80 are axially aligned with one another. To accomplish this, the rotary cams 60 and the first gears 80 are rotatably mounted to the first shaft 101 and the second shaft 102, respectively, as shown in FIG. 13.

Referring to FIG. 13, a gear 103 is mounted on the second shaft 102. The gear 103 has a recessed portion 104 engaged with a second protrusion 82 of the first gear 80a. With the arrangement, when the motor 30 rotates in the first and second directions C1 and C2, the first gear 80a is rotated in the fifth and sixth directions C5 and C6. Alternatively, although not shown in the figures, the motor 30 may be directly coupled to the first gear 80a.

The rotary cam 60a is rotated in the third direction C3 to move the cap member 40a to the uncapped position. In this situation, the rotary cam 60b should not be rotated. Accordingly, the first gear 80b should not be rotated when the first gear 80a rotates the rotary cam 60a. To accomplish this, the first delaying means 89 allows a preceding first gear 80a to be coupled to a subsequent first gear 80b after a delay corresponding to the phase difference between the first and second cams 61 and 62 of the rotary cam 60. As described above, the phase difference between the first and second cams 61 and 62 is set to 180 degrees.

Referring to FIG. 13, the first delaying means 89 includes a first protrusion 81 formed at the preceding first gear 80a and a second protrusion 82 formed at the subsequent first gear 80b. The first gear 80a is rotated in the fifth direction C5 to cause the rotary cam 60a to rotate in the third direction C3. Preferably, the second protrusion 82 is spaced apart from the first protrusion 81 in the fifth direction C5 at an angle greater than 180 degrees. In this embodiment, the second protrusion 82 initially contacts a side of the first protrusion 81 facing the sixth direction C6 of the first protrusion 81. Accordingly, when the first gear 80a is rotated in the fifth direction C5, the first protrusion 81 is spaced apart from the second protrusion 82, so that the first gear 80b is not rotated. If the rotary cam 60a is rotated at an angle of 180 degrees, the cap member 40a is moved to the uncapped position, as shown in FIG. 9. Since the first gear 80a meshes with the idle portion 69, as shown in FIG. 12, the rotary cam 60a stops rotating. If the first gear 80a is continuously rotated in the fifth direction C5, as shown in FIG. 14, the first protrusion 81 of the first gear 80a contacts a side of the second protrusion 82 of the first gear 80b facing to the sixth direction C6. If the first gear 80a is further rotated in the fifth direction C5, the first protrusion 81 pushes the second protrusion 82, so that the first gear 80b starts rotating. Accordingly, the rotary cam 60b is rotated, and the cap member 40b is moved to the uncapped position.

With the above described uncapping unit 110, if the motor 30 continuously rotates in the first direction C1, the cap member 40a located at one end of the nozzle unit 11 is uncapped first and the rest of the cap members 40 are sequentially moved to the uncapped position. Thus, the proper number of cap members 40 can be moved to the uncapped position in line with a predetermined or detected size of paper P, and the motor 30 can then be stopped. For example, the number of cap members 40 moved to the uncapped position can be calculated by detecting the amount of rotation the motor 30. The paper P is transferred by a pair of carry rollers 20, and the nozzles of the uncapped nozzle section 13 project the ink onto the paper to print the image. After completing the print, the nozzle section 13 is again capped by actuating the capping unit 120.

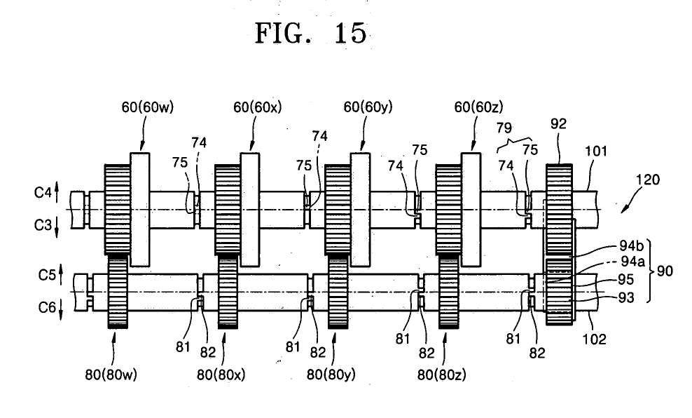

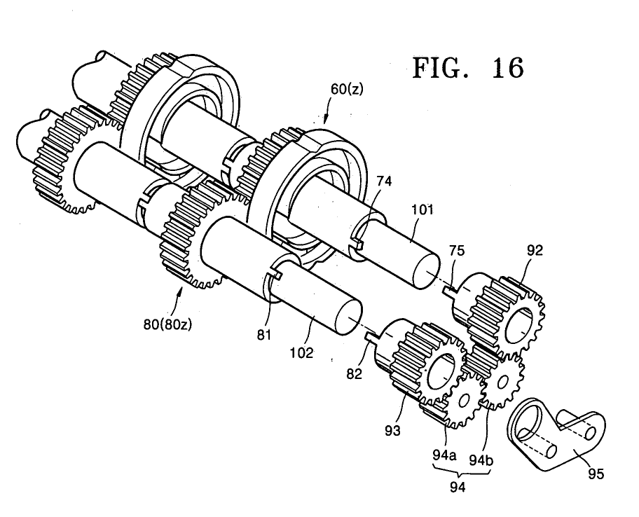

Referring to FIGS. 15 and 16, the capping unit 120 includes a second gear 92, a transmitting means 90, and a second delaying means 79. The second gear 92 is installed on the first shaft 101, and rotates the rotary cam 60z spaced farthest from the rotary cam located at the far end of the nozzle unit 11 (in other words, the rotary cam 60a). The transmitting means 90 transmits the rotational force of the motor 30 to the second gear 92 when the motor 30 rotates in the second direction C2. When the second gear 92 is rotated in the fourth direction C4, the driving force is transmitted from the rotary cam 60z to the rotary cam 60a through the second delaying means 79. The subsequent rotary cam 60b should not be rotated by the preceding rotary cam 60a in the uncapping process. Specifically, the second delaying means 79 keeps the subsequent rotary cam 60b in a stopped state while the rotary cam 60a rotates in the third direction C3 by at least the phase difference between the first and second cams 61 and 62 in the uncapping process.

The transmitting means 90 includes a third gear 93, a swing arm 95, and coupling gears 94a and 94b. The third gear 93 is axially aligned with the plurality of first gears 80. The third gear 93 is installed towards the end of the second shaft 102, and is rotated by the first gear 80z that is spaced farthest from the first gear located at the far end of the nozzle unit 11 (in other words, the first gear 80a). The swing arm 95 is pivotally engaged to the second shaft 102, and the coupling gears 94a and 94b are installed on the swing arm 95. The coupling gear 94a meshes with the third gear 93, while the coupling gear 94a meshes with the coupling gear 94b. A first delaying means 89 may be interposed between the first gear 80z and the third gear 93.

The second delaying means 79 includes a fourth protrusion 74 provided at the preceding rotary cam 60y and a fifth protrusion 75 provided at the subsequent rotary cam 60z. The fifth protrusion 75 is spaced apart from the fourth protrusion 74 in the third direction C3 at a distance corresponding to the phase difference between the first and second cams 61 and 62. A plurality of rotary cams 60 is rotated in the third direction C3 to uncap the cam member 40. In this embodiment, the fifth protrusion 75 contacts the side of the fourth protrusion 74 that faces the fourth direction C4. Since the cap members 40a through 40x are already moved to the uncapped position, each of the rotary cams 60a through 60x is rotated in the third direction C3 at an angle of 180 degrees.

Accordingly, the fourth protrusions 74 of the rotary cams 60a through 60w contact the sides of the fifth protrusions 75 of the rotary cams 60b through 60x that face the fourth direction C4. The second delaying means 79 may be interposed between the second gear 92 and the rotary cam 60z.

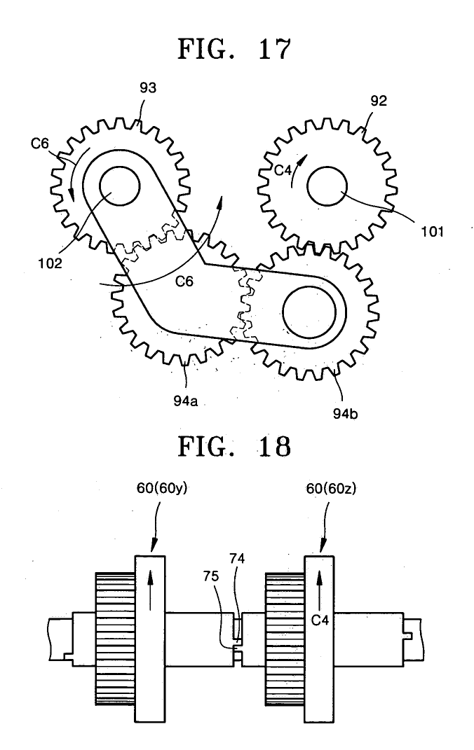

The operation of the mechanism described above will now be described. To facilitate the description, an exemplary case where the cap members 40a through 40x are moved to the uncapped position by the uncapping unit 110 is described. The motor 30 is rotated in the second direction C2 to perform the capping operation. A plurality of first gears 80 are rotated in the sixth direction C6. In the process of moving the cap members 60a through 60x to the uncapped position, the first protrusions 81 of the first gears 80a through 80x contact the sides of the second protrusions 82 of the first gears 80b through 80y facing the sixth direction C6. Accordingly, when the motor 30 is rotated: in the second direction C2, the first gear 80a is immediately rotated, but the first gear 80b is not rotated until the first protrusion 81 of the first gear 80a contacts the side of the second protrusion 82 of the first gear 80b facing to the fifth direction C5. Thus, if the motor 30 continuously rotates, the first gears 80b through 80x are sequentially rotated in the sixth direction C6 by the action of the first delaying means 89. Since the first gears 80a through 80x mesh with the idle portions 69 of the rotary cam 60a through 60x, the rotary cams 60a through 60x are not rotated. If the first protrusion 81 of the first gear 80x is in contact with the side of the second protrusion 82 of the first gear 80y facing the fifth direction C5, the first gear 80y is rotated. Since the first protrusion 81 of the first gear 80y contacts the side of the second protrusion 82 of the first gear 80z facing the fifth direction C5, the first gears 80y and 80z are simultaneously rotated in the sixth direction C6 by the first gear 80z. The third gear 93 is rotated in the sixth direction C6 by the first gear 80z. Since the third gear 93 meshes with the coupling gears 94a and 94b, the rotational force is transmitted from the third gear 93 to the swing arm 95. The swing arm 95 is pivotally moved in the sixth direction C6, as shown in FIG. 17, so that the coupling gear 94b meshes with the second gear 92. The second gear 92 rotates the rotary cam 60z in the fourth direction C4.

Referring to FIG. 15, the fifth protrusion 75 of the rotary cam 60z contacts the side of the fourth protrusion 74 of the rotary cam 60y facing the fourth direction C4. Accordingly, after the fifth protrusion 75 of the rotary cam 60z contacts the side of the fourth protrusion 74 of the rotary cam 60y facing the third direction C3, as shown in FIG. 18, the rotary cam 60y starts rotating. Without considering the thickness of the fourth and fifth protrusions 74 and 75, the fifth protrusion 75 of the rotary cam 60y is spaced apart from the fourth protrusion 74 of the rotary cam 60x in the fourth direction C4 at a distance corresponding to the results obtained by subtracting the phase difference between the first and second cams 61 and 62 from 360 degrees. Accordingly, the rotary cam 60x is delayed with respect to the rotary cam 60y by the value obtained by subtracting the phase difference between the first and second cams 61 and 62 from 360 degrees. At this stage, the cap members 40z and 40y are capped. Although the rotary cams 60z and 60y are rotated in the fourth direction C4, the cap members 40z and 40y are continuously supported by the first cam 61 to keep them in the capped position, due to the operation of the ramp 63 shown in FIG. 10. When the rotary cam 60x starts rotating, the rotary cams 60x through 60a are sequentially rotated, and the cap members 40x through 40a are sequentially moved to the capped position. When the cap member 60a is moved to the capped position, the motor 30 is stopped. After the cap members 40z through 40a are sequentially moved to the capped position, although the motor 30 continuously rotates in the second direction C2, the cap members 40z through 40a are maintained in the capped position due to the operation of the ramp 63 shown in FIG. 10. Since the cap drive unit 100 of the present invention includes a plurality of resilient members 50 for resiliently biasing the plurality of cap members 40 towards the capped position, a plurality of rotary cams 60 allows the cap members 40 to move in the direction of the resilient force of the resilient members 50. Accordingly, little load is applied to the motor 30 during the capping operation.

After the above-described uncapping/capping operation is completed, the plurality of first delaying means 89 are arranged in the state shown in FIG. 13, while the plurality of second delaying means 79 are arranged in the same state as the second delaying means 79 between the rotary cams 40y and 40z shown in FIG. 15. With the above construction and process, the cap members 40 are sequentially moved to the uncapped position across the width of the paper P, and after completion of the printing, the cap members 40 are sequentially moved to the capped position.

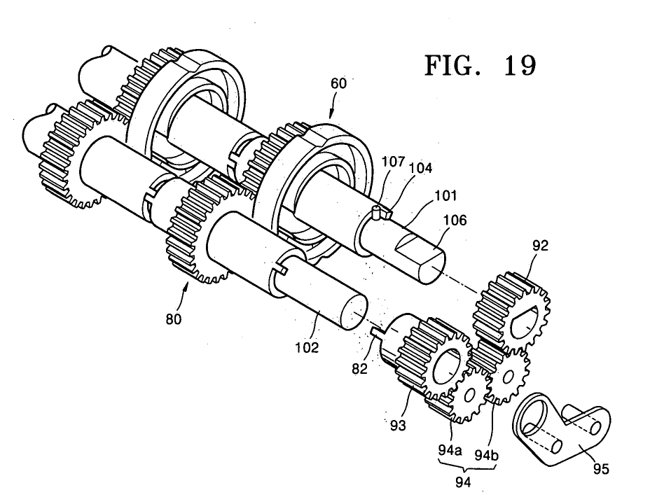

FIG. 19 shows an alternative embodiment of the capping unit 120 in FIG. 16. Referring to FIG. 19, an end of a first shaft 101 is provided with a D-shaped cut portion 106. The second gear 92 is inserted into the D-shaped cut portion 106, and a pin 107 is inserted into a first shaft 101. With the above arrangement, when the motor 30 rotates in the second direction C2, the first shaft 101 is rotated in the fourth direction C4. The pin 107 pushes the fourth protrusion 74 of the rotary cam 60z to rotate the rotary cam 60z in the fourth direction C4. The capping operation is identical to that described above.

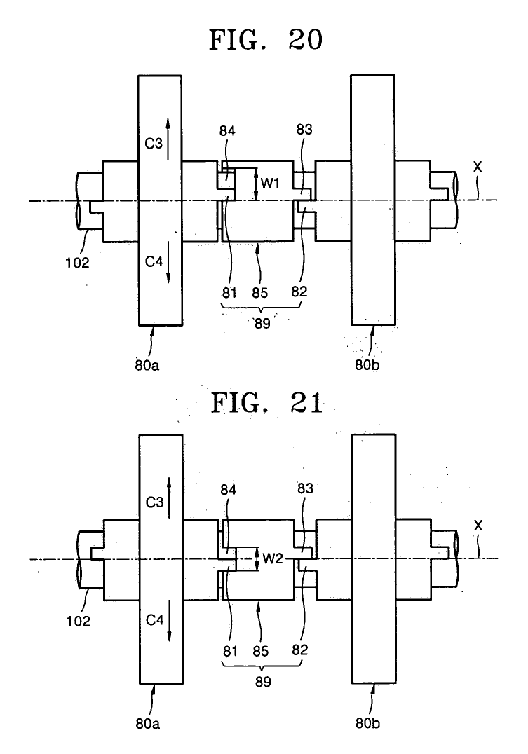

The first delaying means 89 shown in FIG. 13 has a delay angle of less than 360 degrees, because of the thickness of the first and second protrusions 81 and 82. If the first gear 80 has the same number of teeth as the geared portion 68 of the rotary cam 60 and the delay angle due to the first delaying means 89 is 360 degrees, it is very easy to control the cap drive unit 100. Specifically, whenever the first gear 80 is rotated once in the fifth direction C5, the cap members 40 are moved to the uncapped position one by one. Thus, if the revolutions of the first gear 80 are detected, it is possible to know how many cap members 40 are moved to the uncapped position. Reference is now made to FIGS. 20 through 22 which illustrate three embodiments of the first delaying means 89 where the delay angle is 360 degrees. Of course, the present invention is not limited to that delay angle.

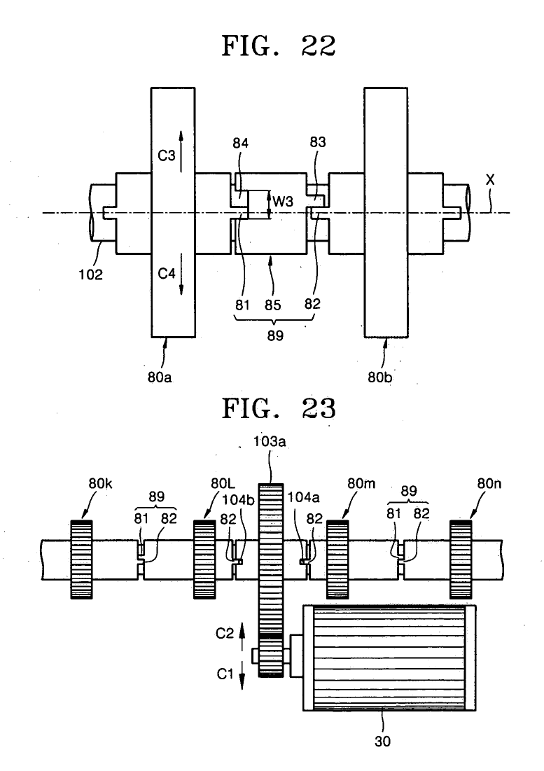

Referring to FIGS. 20 through 22, the first gear 80a is provided with a first protrusion 81, while the second gear 80b is provided with a second protrusion 82. A sleeve 85 is interposed between the first and second gears 80a and 80b. The sleeve 85 is provided with a third protrusion 83 and a first recessed portion 84 for receiving the first protrusion 81. The third protrusion 83 contacts the end of the second protrusion 82 facing to the third direction C3. Referring to FIG. 20, the first and second protrusions 81 and 82 are located at the third and fourth directions C3 and C4 around a rotational axis X, respectively. In this case, the width W1 of the first recessed portion 84 relative to the rotation direction is identical to the sum total of the thickness of the first, second and third protrusions 81, 82 and 83 relative to the direction of rotation. Referring to FIG. 21, the first and second protrusions 81 and 82 are located at the fourth direction C4 around the rotational axis X. In this case, the width W2 of the first recessed portion 84 relative to the direction of rotation is identical to the sum of the thickness of the first and third protrusions 81 and 83 relative to the direction of rotation. Referring to FIG. 22, the first and second protrusions 81 and 82 are located on the rotational axis X. In this case, the width W3 of the first recessed portion 84 relative to the rotation direction is identical to the sum of one half of the thickness of the first and second protrusions 81 and 82 and the thickness of the third protrusion 83.

Referring to FIGS. 6 through 22, the cap drive unit 100 sequentially moves the cap members 40 to the uncapped position, starting from the cap member 40a located at one side of the paper P. Preferably, the cap drive unit 100 is used in printers where the paper P is aligned on one side of the printer irrespective of the width of the paper. FIG. 23 shows an embodiment of the cap drive unit 100 used where the paper P aligned at the center of the printer regardless of the width of the paper. Referring to FIG. 23, a gear 103a is interposed between a first gear 80L and a first gear 80m. Both sides of the gear 103a are provided with recessed portions. 104a and 104b. The recessed portions 104a and 104b respectively receive a second protrusion 82 of the first gear 80L and a second protrusion 82 of the first gear 80m. The motor 30 rotates the gear 103a. A first delaying means 89 is interposed between the first gears 80L and 80k and between the first gears 80m and 80n, respectively. Of course, the motor 30 may be directly coupled to the first gear 80m. The first and second shafts 101 and 102 are provided with the same capping unit 120 as those shown in FIGS. 15 through 18. With this arrangement, when the motor 30 rotates in the first direction C1, the plurality of cap members 40 are sequentially moved to the uncapped position, starting from the cap members 80m and 80L and progressing across the width of the paper P. When the motor 30 rotates in the second direction C2, the cap members 40 are sequentially moved to the capped position, starting from the cap members 80a and 80z and progressing towards the center of the paper P.

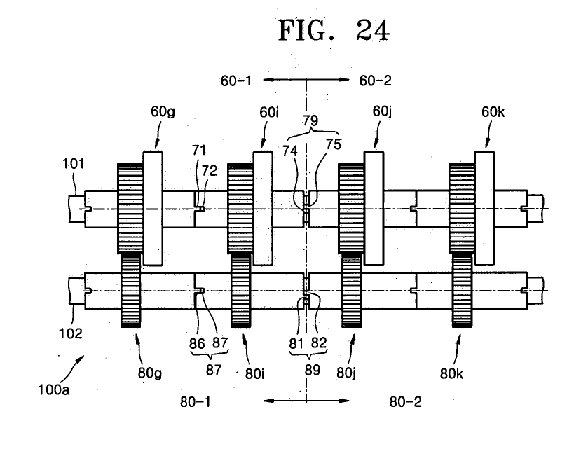

A plurality of cam members 40 are divided into many cap groups 40-1, 40-2 and 40-3 including at least one cap member 40, as shown in FIG. 5A. The cap drive unit 100a sequentially moves the cap groups 40-1, 40-2 and 40-3 to the uncapped position one by one. In this case, the rotary cams 60 and the first gears 80 are divided into three rotary cam groups and three first gear groups each corresponding to each of the cap groups 40-1, 40-2 and 40-3. The first gears 80 associated with the same group are engaged in series to each other such that the first gears 60 are rotated at the same time, and the first delaying means 89 is interposed only between the first gear groups. The rotary cams 60 associated with the same group are engaged in series to each other such that the rotary cams 60 rotate at the same time, and the second delaying means 79 is interposed only between rotary cam groups. FIG. 24 shows rotary cam groups 60-1 and 60-2 and first gear groups 80-1 and 80-2 corresponding to the cap groups 40-1 and 40-2. A first gear 80g and a first gear 80i associated with the first gear group 80-1 are simultaneously rotated by connection of the protrusion 86 and the recessed portion 87. A first gear 80k and a first gear 80j area associated with the first gear group 80-2. A first delaying means 89 is interposed between the first gear 80i and the first gear 80j (which are associated with the first gear groups 80-1 and 80-2). A rotary cam 60g and a rotary cam 60i associated with the rotary cam group 60-1 are simultaneously rotated by connection of the protrusion 71 and the recessed portion 72. A rotary cam 60k and a rotary cam 60j are associated with the rotary cam group 60-2. A second delaying-means 79 is interposed between the rotary cam 60i and the rotary cam 60j which are associated with the rotary cam groups 60-1 and 60-2. The capping unit 120 described with respect to FIGS. 16 through 19 may be used. With this arrangement, the cap groups 40-1, 40-2 and 40-3 can be sequentially moved to the capped/uncapped positions.

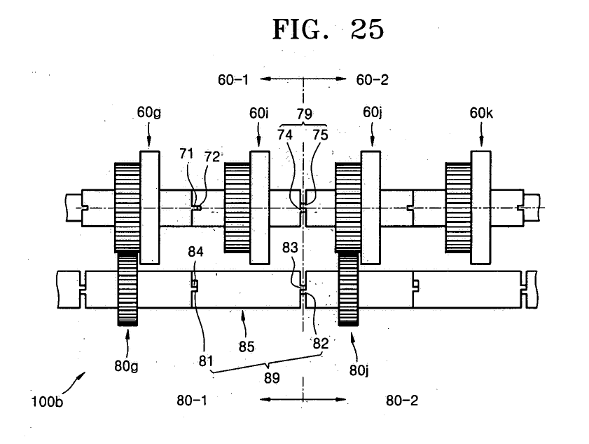

A cap drive unit 100b shown in FIG. 25 is an alternative embodiment of the cap drive unit 100a shown in FIG. 24, and includes the same number of first gears 80 as that of the rotary cam groups. The cap drive unit 100b may include three first gears 80, in the case of dividing the cap groups 40-1, 40-2 and 40-3, as shown in FIG. 5A. For example, the first gear 80g meshes with the geared portion 68 of the rotary cam 60g of the rotary cam group 60-1, while the first gear 80j meshes with the geared portion 68 of the rotary cam 60j of the rotary cam group 60-2. The second delaying means 79 is interposed between the rotary cam 60i and the rotary cam 60j each pertaining to the rotary cam groups 60-1 and 60-2, while the first delaying means 89 is interposed between the first gear 80g and the first gear 80j, as shown in FIG. 20. With the above arrangement, the cap groups 40-1, 40-2 and 40-3 are sequentially moved to the capped/uncapped positions.

It would be understood to one skilled in the art that embodiments of the cap drive units shown in FIGS. 23 to 25 may be suitably modified to drive the divided cap groups shown in FIG. 5B.

An inkjet printer built in accordance with these above described exemplary embodiments of the invention is advantageous in that it is possible to uncap only the nozzle section used for printing in accordance with the width of the paper being printed on. In addition, it is possible to reduce a drive load of the motor driving the cam drive unit by moving the cap members to the capped/uncapped positions one by one.

While the present invention has been particularly shown and described with reference to exemplary embodiments, it will be understood by those of ordinary skill in the art that various changes and modifications in form and details may be made therein without departing from the spirit and scope of the present invention. as defined by the following claims.

What is claimed is:

1. An inkjet printer comprising:
a printing head including a nozzle unit having a length corresponding to the width of a paper being printed on, the printing head printing an image on the paper by projecting ink onto the paper from a stationary position, the nozzle unit being divided into a plurality of nozzle sections;
a plurality of cap members each corresponding to at least one nozzle section;
a cap drive unit for moving the plurality of cap members between a capped position and an uncapped position; and
a motor for driving the cap drive unit.

2. The inkjet printer of claim 1, wherein
the plurality of cap members are divided into a plurality of cap groups including at least one cap member, and the cap drive unit sequentially moves the cap groups to the uncapped position one by one.

3. The inkjet printer of claim 2, wherein
the cap drive unit sequentially moves the cap group to the uncapped position starting from the cap group located at one side of the paper.

4. The inkjet printer of claim 2, wherein
the cap drive unit sequentially moves the cap group to the uncapped position starting from the cap group located at the center of the paper.

5. The inkjet printer of claim 1, wherein the cap drive unit includes
a plurality of rotary cams corresponding to the plurality of cap members, each rotary cam including
a first cam supporting the cap member at the capped position,
a second cam supporting the cam member at the uncapped position and spirally engaged to the first cam, and
a ramp for selectively allowing the first and second cams to be engaged depending upon the direction of rotation;
a plurality of resilient members for applying a resilient force to the plurality of cap members in a direction toward the capped position;
an uncapping unit for rotating the rotary cam in a third direction to move the plurality of cam members in a direction opposite to the resilient force when the motor rotates in a first direction; and
a capping unit for rotating the rotary cam in a fourth direction to allow the plurality of cam members to move in the same direction as the resilient force when the motor rotates in a second direction.

6. The inkjet printer of claim 5, further comprising:
locking means for locking the rotary cam in the capped position or in the uncapped position.

7. The inkjet printer of claim 6, wherein the locking means includes
first and second locking portions formed at an outer periphery of the rotary cam at positions corresponding to the capped position and the uncapped position, respectively; and
a resilient engaging member resiliently contacting the outer periphery of the rotary cam and resiliently engaging the first and second locking portions in the capped and uncapped positions, respectively.

8. The inkjet printer of claim 5, wherein the uncapping unit includes
a plurality of first gears corresponding to the plurality of rotary cams, one of the first gears being rotated by the motor; and
a geared portion provided for each of the rotary cams, the geared portion meshing with the first gear, the geared portion having an idle portion with no teeth; and
a plurality of first delaying means for delaying a preceding first gear and a subsequent first gear by at least an interval corresponding to a phase difference between the first and second cams when the preceding first gear is engaged to the subsequent first gear.

9. The inkjet printer of claim 8, wherein
the plurality of rotary cams and the plurality of first gears are axially aligned.

10. The inkjet printer of claim 9, wherein the first delaying means includes
a first protrusion provided on the preceding first gear; and
a second protrusion provided on the subsequent first gear to engage with the first protrusion, the second protrusion being spaced apart from the first protrusion by at least the interval corresponding to the phase difference between the first and second cams.

11. The inkjet printer of claim 9, wherein
the geared portion has the same number of teeth as that of the first gear, and the first delaying means delays the preceding first gear and the subsequent first gear by an angle of 360 degrees when the preceding first gear is engaged to the subsequent first gear.

12. The inkjet printer of claim 8, wherein the capping unit includes
a second gear for rotating the rotary cam located at one side of the paper in a widthwise direction;
means for transmitting a rotational force of the motor to the second gear when the motor rotates in the second direction; and
second delaying means for keeping the subsequent rotary cam in a stopped state while the preceding rotary cam is rotated in the third direction by at least the phase difference between the first and second cams.

13. The inkjet printer of claim 12, wherein
the plurality of rotary cams and the plurality of first gears are axially aligned.

14. The inkjet printer of claim 13, wherein the transmitting means includes
a third gear axially aligned with the plurality of first gears and rotated by the first gear;
an even number of coupling gears meshing with the third gear; and
a swing arm pivoting about an axis aligned with the axis of the third gear,
wherein the coupling gears are installed on one side of the swing arm and are pivoted to mesh one of the coupling gears with the second gear when the motor rotates in the second direction.

15. The inkjet printer of claim 12, wherein the second delaying means includes
a fourth protrusion provided at a preceding rotary cam; and
a fifth protrusion provided at a subsequent rotary cam to engage with the fourth protrusion, the fifth protrusion being spaced apart from the fourth protrusion in the third direction at a distance corresponding to the phase difference between the first and second cams.

16. The inkjet printer of claim 12, wherein
the plurality of cap members, the plurality of rotary cams, and the plurality of first gears are divided into a plurality of cap groups, a plurality of rotary cam groups, and a plurality of first gear groups, each including the same number of the cap members, rotary cams and first gears; the rotary cams and first gears associated with the same group being rotated simultaneously; and
the first and second delaying means are interposed between each of the rotary cam groups and the first gear groups.

17. The inkjet printer of claim 12, wherein
the plurality of cap members and the plurality of rotary cams are divided into a plurality of cap groups and a plurality of rotary cam groups, each including the same number of cap members and rotary cams;
the rotary cams associated with the same group are rotated simultaneously;
the number of first gears is identical to the number of rotary cap groups, and the first gears mesh with the geared portions of the rotary cam in the corresponding rotary cam group; and
wherein the first and second delaying means are interposed between the first gears and the rotary cam groups.

18. The inkjet printer of claim 17, wherein
the cap drive unit sequentially moves the plurality of cap members to the uncapped position one by one.

19. The inkjet printer of claim 1, wherein
the cap drive unit sequentially moves the plurality of cap members to the capped position one by one.
